(19) United States
(12) Patent Application Publication
(10) Pub. No.: US 2025/0253635 A1
(43) Pub. Date: Aug. 7, 2025

(54) ADDITIONAL WIRING FIXING MEMBER AND WIRING FIXING STRUCTURE

(71) Applicants: Sumitomo Wiring Systems, Ltd., Mie (JP); TOYOTA JIDOSHA KABUSHIKI KAISHA, Aichi (JP)

(72) Inventors: Tatsumi SATO, Mie (JP); Kazuhiro NISHIMURA, Mie (JP); Hirozumi OKANIWA, Mie (JP); Motohiro YOKOI, Mie (JP); Muneyuki FUJISAKA, Aichi (JP)

(73) Assignees: Sumitomo Wiring Systems, Ltd., Mie (JP); TOYOTA JIDOSHA KABUSHIKI KAISHA, Aichi (JP)

(21) Appl. No.: 18/857,050

(22) PCT Filed: Apr. 14, 2023
(86) PCT No.: PCT/JP2023/015189

§ 371 Date: Oct. 15, 2024

(30) Foreign Application Priority Data
Apr. 22, 2022 (JP) 2022-070552

(51) Int. Cl. H02G 3/32; B60R 16/02

(52) U.S. Cl. CPC H02G 3/32; B60R 16/0215

(57) ABSTRACT

Provided is an additional wiring fixing member for fixing an additional wiring to a fixing target region using a wiring fixing member including a vehicle fixing part inserted and fixed to a fixing hole of the fixing target region on a side of a vehicle, including: a plate-like vehicle fixing part formed into a plate-like shape with an insertion hole into which the vehicle fixing part can be inserted and sandwiched between the vehicle fixing part and the fixing target region to be fixed to the fixing target region; and an additional wiring holding part continuously formed with the plate-like vehicle fixing part to hold the additional wiring.

### TECHNICAL FIELD

The present disclosure relates to an additional wiring fixing member and a wiring fixing structure.

### BACKGROUND ART

Patent Document 1 discloses that a first clamp body part of a first clamp to which a first wire harness is fixed is locked to a body panel, a second clamp insertion hole is provided to the first clamp, and a second clamp body part of a second clamp is locked to a body panel via the second clamp insertion hole.

### PRIOR ART DOCUMENTS

### Patent Document(s)

Patent Document 1: Japanese Patent Application Laid-Open No. 2008-295121

### SUMMARY

### Problem to be Solved by the Invention

According to a technique disclosed in Patent Document 1, the first clamp and the second clamp both having special shapes need to be used. It is desired that an additional wiring can be easily fixed using an attachment structure of an existing wiring.

Accordingly, an object of the present disclosure is to be able to easily fix an additional wiring to a vehicle using an attachment structure of an existing wiring.

### MEANS TO SOLVE THE PROBLEM

An additional wiring holding member according to the present disclosure is an additional wiring fixing member for fixing an additional wiring to a fixing target region using a wiring fixing member including a vehicle fixing part inserted and fixed to a fixing hole of the fixing target region on a side of a vehicle, the additional wiring fixing member including: a plate-like vehicle fixing part formed into a plate-like shape with an insertion hole into which the vehicle fixing part can be inserted and sandwiched between the vehicle fixing part and the fixing target region to be fixed to the fixing target region; and an additional wiring holding part continuously formed with the plate-like vehicle fixing part to hold the additional wiring.

A wiring fixing structure according to the present disclosure is a wiring fixing structure for fixing a wiring and an additional wiring to a fixing target region on a side of a vehicle, including: a wiring fixing member including a vehicle fixing part inserted and fixed to a fixing hole of the fixing target region; and an additional wiring fixing member including a plate-like vehicle fixing part formed into a plate-like shape with an insertion hole into which the vehicle fixing part can be inserted and an additional wiring holding part continuously formed with the plate-like vehicle fixing part to hold the additional wiring, wherein a peripheral edge of the insertion hole in the plate-like vehicle fixing part is sandwiched between the vehicle fixing part and the fixing target region to be fixed to the fixing target region.

### Effects of the Invention

According to the present disclosure, an additional wiring can be easily fixed to a vehicle using an attachment structure of an existing wiring.

### BRIEF DESCRIPTION OF DRAWINGS

FIG. 1 is a perspective view illustrating a wiring fixing structure according to an embodiment.

FIG. 2 is a side view illustrating the wiring fixing structure.

FIG. 3 is a back view illustrating the wiring fixing structure.

FIG. 4 is a perspective view illustrating a wiring fixing member and an additional wiring fixing member.

FIG. 5 is a perspective view illustrating a wiring fixing member and an additional wiring fixing member according to a first modification example.

FIG. 6 is a perspective view illustrating an additional wiring holding member according to a second modification example.

FIG. 7 is a side view illustrating a wiring fixing member and an additional wiring fixing member according to the second modification example.

### DESCRIPTION OF EMBODIMENT(S)

### Description of Embodiments of Present Disclosure

Embodiments of the present disclosure are listed and described firstly.

An additional wiring holding member according to the present disclosure is as follows.
(1) An additional wiring fixing member for fixing an additional wiring to a fixing target region using a wiring fixing member including a vehicle fixing part inserted and fixed to a fixing hole of the fixing target region on a side of a vehicle, the additional wiring fixing member including: a plate-like vehicle fixing part formed into a plate-like shape with an insertion hole into which the vehicle fixing part can be inserted and sandwiched between the vehicle fixing part and the fixing target region to be fixed to the fixing target region; and an additional wiring holding part continuously formed with the plate-like vehicle fixing part to hold the additional wiring.

The vehicle fixing part of the wiring fixing member is inserted into the insertion hole, thus the plate-like vehicle fixing part can be fixed to the fixing target region using the vehicle fixing part. The additional wiring is held in the additional wiring holding part continuously formed with the plate-like vehicle fixing part, thus the additional wiring can be easily fixed using an attachment structure of the existing wiring.
(2) In the additional wiring fixing member according to (1), it is applicable that the additional wiring holding part is a part including an elongated plate-like part, and a banding member is tied to the additional wiring and the elongated plate-like part while the additional wiring is disposed along the elongated plate-like part, thus the additional wiring is held in the additional wiring holding part.

Accordingly, the additional wiring can be easily held in the additional wiring holding part by a banding member such as an adhesive tape or a banding band.
(3) In the additional wiring fixing member according to (2), the plate-like vehicle fixing part may extend in a direction intersecting with the elongated plate-like part from a longitudinal intermediate part of the elongated plate-like part.
(4) In the additional wiring fixing member according to (1), it is applicable that the additional wiring holding part includes a band fixing part with a band insertion fixing hole and a band part extending from the band fixing part, and the band part is inserted into the band insertion fixing hole while the band part is wound around the additional wiring to have an annular shape, and the band part is kept in a state of being wound around the additional wiring.

The additional wiring holding member keeps the state where the band part is wound around the additional wiring by the band fixing part, thus can hold the additional wiring without the other banding member.
(5) In the additional wiring fixing member according to (4), the plate-like vehicle fixing part may extend in a direction intersecting with a central axis of the band part having an annular shape while the band part is wound around the additional wiring to have the annular shape.

Accordingly, the additional wiring is easily supported in a state of being parallel to the existing wiring.

A wiring fixing member according to the present disclosure is as follows.
(6) A wiring fixing structure for fixing a wiring and an additional wiring to a fixing target region on a side of a vehicle, including: a wiring fixing member including a vehicle fixing part inserted and fixed to a fixing hole of the fixing target region; and an additional wiring fixing member including a plate-like vehicle fixing part formed into a plate-like shape with an insertion hole into which the vehicle fixing part can be inserted and an additional wiring holding part continuously formed with the plate-like vehicle fixing part to hold the additional wiring, wherein a peripheral edge of the insertion hole in the plate-like vehicle fixing part is sandwiched between the vehicle fixing part and the fixing target region to be fixed to the fixing target region.

The vehicle fixing part of the wiring fixing member is inserted into the insertion hole, thus the plate-like vehicle fixing part can be fixed to the fixing target region using the vehicle fixing part. The additional wiring is held in the additional wiring holding part continuously formed with the plate-like vehicle fixing part, thus the additional wiring can be easily fixed using an attachment structure of the existing wiring.

### Detailed Description of Embodiment of Present Disclosure

Specific examples of an additional wiring fixing member and a wiring fixing structure according to the present disclosure are described hereinafter with reference to the drawings. The present disclosure is not limited to these examples, but is indicated by claims, and it is intended that meanings equivalent to claims and all modifications within a scope of claims are included.

### Embodiment

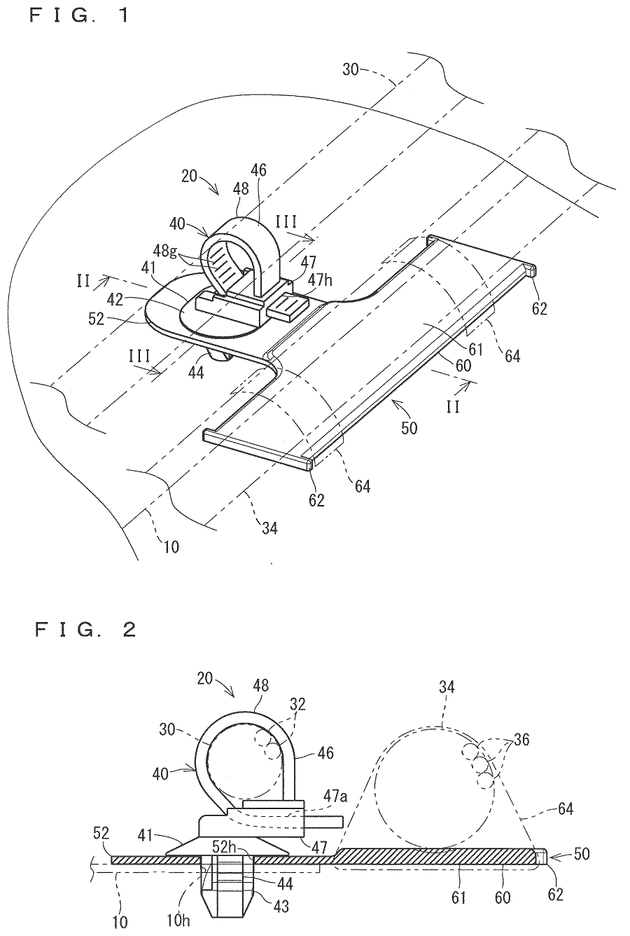

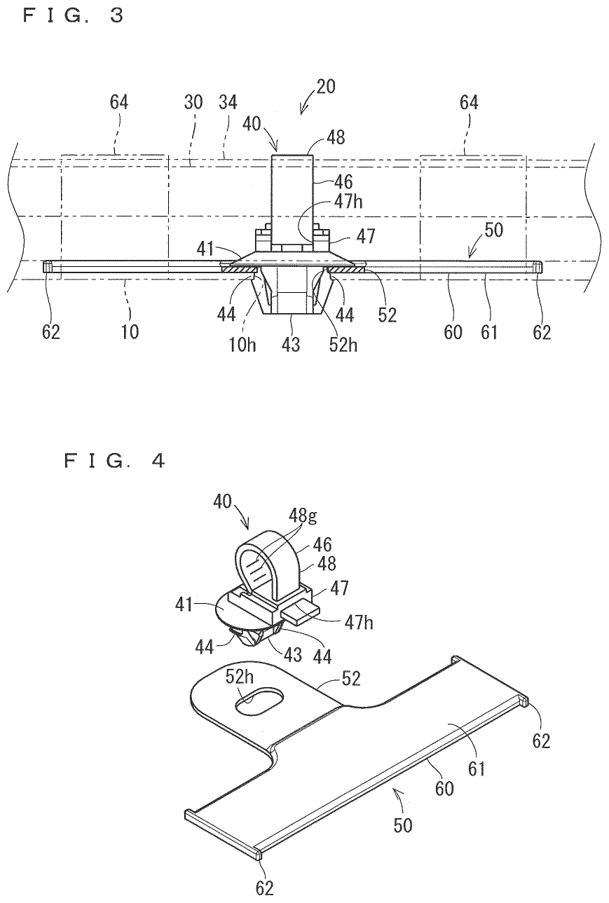

An additional wiring fixing member and a wiring fixing structure according to an embodiment are described hereinafter. FIG. 1 is a perspective view illustrating a wiring fixing structure 20. FIG. 2 is a side view illustrating the wiring fixing structure 20. In FIG. 2, an additional wiring fixing member 50 is illustrated by a cross-sectional view along a II-II line in FIG. 1. FIG. 3 is a back view illustrating the wiring fixing structure 20. In FIG. 3, an additional wiring fixing member 50 is illustrated by a cross-sectional view along a III-III line in FIG. 1. FIG. 1 to FIG. 3 illustrate a part of a fixing target region 10, a wiring 30, and an additional wiring 34. FIG. 4 is a perspective view illustrating the wiring fixing member 40 and the additional wiring fixing member 50.

The wiring fixing structure 20 is a structure for fixing the wiring 30 and the additional wiring 34 to the fixing target region 10.

The fixing target region 10 is assumed to be a plate-like part supported at a constant position in a vehicle. The fixing target region 10 may be a part of a metal panel constituting the vehicle or a part of a bracket fixed to the vehicle, for example. A fixing hole 10h for fixing the wiring 30 is formed in the fixing target region 10. The fixing hole 10h may have a circular shape, an oval hole elongated in one direction, or a rectangular hole.

The wiring 30 includes the wire-like transmission member 32 connecting a plurality of electrical components in the vehicle, for example (partially illustrated in FIG. 2). It is sufficient that the wire-like transmission member 32 is a wire-like member transmitting electricity or light. The wire-like transmission member 32 is an electrical wire transmitting electricity or an optical fiber transmitting light. In the present embodiment, the wire-like transmission member 32 is a covering wire including a core wire and a covering for covering the core wire. The plurality of wire-like transmission members may be collected to constitute a twisted wire or a cable form.

The wiring 30 may include only one wire-like transmission member 32, or may also include the plurality of wire-like transmission members 32. When the wiring 30 includes the plurality of wire-like transmission members 32, the plurality of wire-like transmission members 32 are kept in a bundled state. For example, the plurality of wire-like transmission members 32 may be kept in a bundled state by a band part 48 of the wiring fixing member 40. The plurality of wire-like transmission members 32 may be kept in a bundled state by an adhesive tape or a banding band different from the wiring fixing member 40.

The additional wiring 34 includes at least one wire-like transmission member 36 in the manner similar to the wiring 30 described above (partially illustrated in FIG. 2). In the wiring fixing structure 20, it is assumed that the wiring 30 and the additional wiring 34 pass close to each other but are not bundled together.

The following two cases are assumed as a case where the additional wiring 34 is located separately from the wiring 30.

Assumed firstly is a case where the other additional wiring 34 is added in the case where the wiring 30 is fixed to the fixing target region 10 in the vehicle. For example, the vehicle into which the wiring 30 is incorporated is manufactured as a completed vehicle. Subsequently, an electrical component may be added to the vehicle in a stage of supplying the vehicle to a consumer or after supply thereof in some cases. In this case, the additional wiring 34 is incorporated into the vehicle as a wiring for the electrical component added to the vehicle into which the wiring 30 has been incorporated.

Assumed secondly is a case where the other design in which the additional wiring 34 is added is made separately from the design vehicle into which the wiring 30 is incorporated. For example, the vehicle is designed based on an assumption of the wiring 30 incorporated into the vehicle in common regardless of a difference of vehicle type, a difference of grade, or presence or absence or option. Separately from this vehicle design, the vehicle is designed based on an assumption of adding the additional wiring 34 which is or is not incorporated into the vehicle in accordance with the difference of vehicle type, the difference of grade, or the option. The additional wiring 34 may be a wiring assumed in an initial design or a wiring for an electrical component additionally built in accordance with change of a model after the initial design. In this case, the vehicle in which the additional wiring 34 is added to the wiring 30 is manufactured as necessary. In the second case, an operation of fixing the wiring 30 and the additional wiring 34 to the vehicle can be performed together.

In any case, the additional wiring 34 is fixed based on a premise that there is an actual or design structure of fixing the wiring 30 to the fixing target region 10. Described in the present embodiment as the structure of fixing the wiring 30 to the fixing target region 10 is a configuration of fixing the additional wiring 34 to the fixing target region 10 using the wiring fixing member 40 based on a premise that there is the wiring fixing member 40 including a vehicle fixing part 41 inserted and fixed to the fixing hole 10h of the fixing target region 10.

The wiring fixing member 40 for fixing the wiring 30 to the fixing target region 10 includes the vehicle fixing part 41 and a wiring fixing part 46.

The vehicle fixing part 41 is a part inserted and fixed to the fixing hole 10h of the fixing target region 10. In the present embodiment, the vehicle fixing part 41 includes a fixing base part 42, a columnar part 43, and a locking piece 44.

The fixing base part 42 is formed into a shape extending to be wider than the fixing hole 10h so that the fixing base part 42 does not come out from the fixing hole 10h. In the present embodiment, the fixing base part 42 is formed into a disc spring-like shape, more specifically, an oval disc spring-like shape with a gradually increasing diameter toward a tip end side of the columnar part 43.

The columnar part 43 is formed into an elongated shape protruding from a central part of the fixing base part 42 to a side opposite to the wiring fixing part 46. The columnar part 43 is formed into an elongated shape so as to be able to be inserted into the fixing hole 10h to protrude to an insertion direction of the fixing hole 10h.

The locking piece 44 is formed into a shape gradually spreading from the tip end portion of the columnar part 43 toward a base part of the columnar part 43. In the present embodiment, the pair of locking pieces 44 extend from the tip end portion of the columnar part 43 to sides opposite to each other. A maximum width of the tip end portion of the pair of locking pieces 44 is larger than a maximum diameter of the fixing hole 10h. The pair of locking pieces 44 are formed to be elastically deformable toward the columnar part 43.

Then, when the columnar part 43 and the pair of locking pieces 44 are inserted into the fixing hole 10h, outer slopes of the pair of locking pieces 44 have contact with an edge of the fixing hole 10h and are elastically deformed to a side of the columnar part 43. Accordingly, a maximum width part of the pair of locking pieces 44 can get out of the fixing hole 10h. When the maximum width part of the pair of locking pieces 44 gets out of the fixing hole 10h, the pair of locking pieces 44 are biased to a direction extending outside by elastic restoring force. Accordingly, the maximum width part of the pair of locking pieces 44 can be locked to the edge of the fixing hole 10h in a state of not getting out thereof. In this state, the fixing base part 42 described above has contact with a surrounding part of the fixing hole 10h in the fixing target region 10 from a side opposite to the pair of locking pieces 44. The surrounding part of the fixing hole 10h in the fixing target region 10 is sandwiched between the pair of locking pieces 44 and the fixing base part 42, thus the vehicle fixing part 41 is fixed to the fixing target region 10.

The configuration that the vehicle fixing part 41 includes the pair of locking pieces 44 is not necessary. For example, the vehicle fixing part may have a configuration that a plurality of umbrella-like locking parts protruding around the columnar part 43 are formed along a longitudinal direction of the columnar part 43. The vehicle fixing part having such a configuration is referred to as a tree-like clamp in some cases.

The wiring fixing part 46 is a part fixing the wiring 30. In the present embodiment, the wiring fixing part 46 includes a band fixing part 47 and the band part 48.

The band fixing part 47 is integrally formed with the fixing base part 42 on a side opposite to the columnar part 43. The band fixing part 47 is formed into a flat rectangular cylindrical shape with a band insertion fixing hole 47h. The band insertion fixing hole 47h is formed into a flat rectangular hole-like shape so that the band part 48 can be inserted into the band insertion fixing hole 47h. A band locking piece 47a is formed to protrude in the band insertion fixing hole 47h.

The band part 48 is formed into a thin band-like shape extending from an end portion of the band fixing part 47 on a side of an opening on one side of the band insertion fixing hole 47h. A plurality of locking grooves 48g are formed to be arranged side by side along a longitudinal direction of the band part 48 in one main surface of the band part 48. Each locking groove 48g is formed into an elongated shape along a width direction of the band part 48, and the band locking piece 47a described above is formed to be able to be locked.

Then, the band part 48 is inserted into the band insertion fixing hole 47h while the band part 48 is wound around the wiring 30 to have an annular shape. Then, the band locking piece 47a is locked to a part of the plurality of locking grooves 48g, and the band part 48 is kept in a state of being wound around the wiring 30.

The wiring fixing member 40 is a resin component integrally molded by resin, for example. The wiring fixing member 40 may be a component referred to as a band-equipped clip or a band-equipped clamp, for example.

The additional wiring fixing member 50 fixes the additional wiring 34 to the fixing target region 10 using the configuration of fixing the wiring fixing member 40 described above to the fixing target region 10.

The additional wiring fixing member 50 includes a plate-like vehicle fixing part 52 and an additional wiring holding part 60.

The plate-like vehicle fixing part 52 is formed into a plate-like shape with an insertion hole 52h into which the vehicle fixing part 41 can be inserted. The plate-like vehicle fixing part 52 extends around the fixing hole 10h of the fixing target region 10 to an extent of being able to have contact with one main surface of the fixing target region 10. In the present embodiment, the plate-like vehicle fixing part 52 is formed into a quadrangular plate-like shape with a larger width than the fixing base part 42. A corner parts of the plate-like vehicle fixing part 52 are rounded. The insertion hole 52h may have the same size and shape as the fixing hole 10h, however, this configuration is not necessary.

The plate-like vehicle fixing part 52 is a plate which does not include a part disposed in the fixing hole 10h or is not integral with a part disposed in the fixing hole 10h. In the present embodiment, the plate-like vehicle fixing part 52 is a plate-like member having a constant thickness around the insertion hole 52h. The plate-like vehicle fixing part 52 does not have a configuration of being caught in the fixing target region 10 on its own. The plate-like vehicle fixing part 52 itself can be moved along a surface of the fixing target region 10 before being fixed to the fixing target region 10.

Then, the plate-like vehicle fixing part 52 is overlapped with one main surface of the fixing target region 10, and the fixing hole 10h and the insertion hole 52h are positioned. In this state, the columnar part 43 of the vehicle fixing part 41 and the pair of locking pieces 44 are inserted into the insertion hole 52h and the fixing hole 10h. Then, the pair of locking pieces 44 gets out of the insertion hole 52h and the fixing hole 10h to be locked to a peripheral edge of the fixing hole 10h in a state of not getting out thereof. The fixing base part 42 is pressed against a surrounding area of the insertion hole 52h in the plate-like vehicle fixing part 52 from a side opposite to the fixing target region 10. Accordingly, the fixing target region 10 and the plate-like vehicle fixing part 52 are sandwiched between the pair of locking pieces 44 and the fixing base part 42 around the insertion hole 52h and the fixing hole 10h while the fixing target region 10 and the plate-like vehicle fixing part 52 are overlapped with each other. Accordingly, the plate-like vehicle fixing part 52 is fixed to the fixing target region 10 using the vehicle fixing part 41. Also in this fixing state, the plate-like vehicle fixing part 52 is overlapped with the fixing target region 10 without having a part inserted into the fixing hole 10h.

A thickness caused by adding the plate-like vehicle fixing part 52 is assumed to be absorbed by larger elastic deformation of at least one of the disc spring as the fixing base part 42 and/or the pair of locking pieces 44.

The additional wiring holding part 60 is a part continuously formed with the plate-like vehicle fixing part 52 to hold the additional wiring 34. The additional wiring holding part 60 may hold the additional wiring 34 solely by itself, or may also hold the additional wiring 34 in combination with the other component.

In the present embodiment, the additional wiring holding part 60 includes an elongated plate-like part 61. Herein, a protrusion part 62 protruding to an outer side in a width direction is formed on each of both end portions of the elongated plate-like part 61.

A banding member 64 is tied to the additional wiring 34 and the elongated plate-like part 61 while the additional wiring 34 is disposed on one main surface of the elongated plate-like part 61 along the elongated plate-like part 61. For example, the banding member 64 is an adhesive tape. The banding member may be a banding band. Accordingly, the additional wiring 34 is held by the additional wiring holding part 60. In this state, the protrusion part 62 described above can have a role to suppress the banding member 64 coming out from the end portion of the elongated plate-like part 61.

The plate-like vehicle fixing part 52 extends to a direction intersecting with the elongated plate-like part 61 from a longitudinal intermediate part of the elongated plate-like part 61, that is a direction perpendicular to the elongated plate-like part 61 in the present embodiment. Accordingly, the additional wiring 34 can be easily supported in parallel to the wiring 30 adjacent to the plate-like vehicle fixing part 52 sandwiched between the wiring fixing member 40 fixing the wiring 30 and the fixing target region 10.

The additional wiring holding part 60 describe above may be thicker than the plate-like vehicle fixing part 52. Accordingly, the additional wiring holding part 60 can be firmly held. The plate-like vehicle fixing part 52 is thinner than the additional wiring holding part 60, thus can be additionally disposed to be overlapped with the fixing target region 10 between the fixing base part 42 and the pair of locking pieces 44.

It is sufficient that the plate-like vehicle fixing part 52 is fixed to the fixing target region 10 using the vehicle fixing part 41 after the additional wiring 34 is held by the additional wiring holding part 60. However, the additional wiring 34 may be held by the additional wiring holding part 60 after the plate-like vehicle fixing part 52 is fixed to the fixing target region 10.

The wiring fixing member 40 described above may be a resin component integrally molded by resin, for example. The wiring fixing member 40 may be a metal plate. The wiring fixing member 40 may be a component in combination of metal and resin by insert molding, for example.

According to the additional wiring fixing member 50 and the wiring fixing structure 20 having such a configuration, the vehicle fixing part 41 of the wiring fixing member 40 is inserted into the insertion hole 52h of the plate-like vehicle fixing part 52, thus the plate-like vehicle fixing part 52 can be fixed to the fixing target region 10 using the vehicle fixing part 41. Then, the additional wiring 34 is held in the additional wiring holding part 60 continuously formed with the plate-like vehicle fixing part 52, thus the additional wiring 34 can be easily fixed to the fixing target region 10 using the attachment structure of the existing wiring 30.

For example, when the other additional wiring 34 is added in the case where the wiring 30 is fixed to the fixing target region 10 in the vehicle, the additional wiring 34 is assumed to be fixed to the existing wiring 30 by an adhesive tape or a banding band. In such a case, there is a possibility that workability on the vehicle is worsened, banding positions are misaligned, and such a configuration has a poor appearance.

According to the present embodiment, it is sufficient that previously prepared is the additional wiring holding part 60 fixed to the additional wiring 34, and after the wiring fixing member 40 gets out of the fixing hole 10h, the vehicle fixing part 41 of the wiring fixing member 40 is inserted and fixed to the insertion hole 52h and the fixing hole 10h while the plate-like vehicle fixing part 52 is overlapped with the fixing target region 10. Thus, the banding operation, for example, needs not be performed on the vehicle, the fixing operation can be favorably performed, the fixing positions are aligned, and the appearance can be improved.

When a possibility of adding the additional wiring 34 is determined in advance, a fixing hole for additional fixation is considered to be formed in the fixing target region 10 in advance. In this case, the fixing hole for additional fixation is formed in the fixing target region 10 of all of the vehicles regardless of a magnitude of the possibility to be actually added, thus such a configuration may cause increase of cost. In the present embodiment, the additional wiring fixing member 50 is added when the additional wiring 34 is necessary, thus it takes only local cost, thus such a configuration hardly causes increase of cost for the whole vehicle to which the additional wiring 34 is to be added.

The additional wiring holding part 60 includes the elongated plate-like part 61, thus the additional wiring 34 can be easily held in the additional wiring holding part 60 by the banding member 64 such as an adhesive tape or a banding band.

The plate-like vehicle fixing part 52 protrudes from the longitudinal intermediate part of the elongated plate-like part 61, thus the additional wiring 34 held by the elongated plate-like part 61 adjacent to the plate-like vehicle fixing part 52 can be easily fixed in a state of being parallel to the wiring 30.

### Modification Example

Various modification examples are described based on a premise of the embodiment described above.

The configuration that the wiring fixing member 40 holds the wiring 30 needs not be the configuration of including the band part 48 as with the embodiment described above.

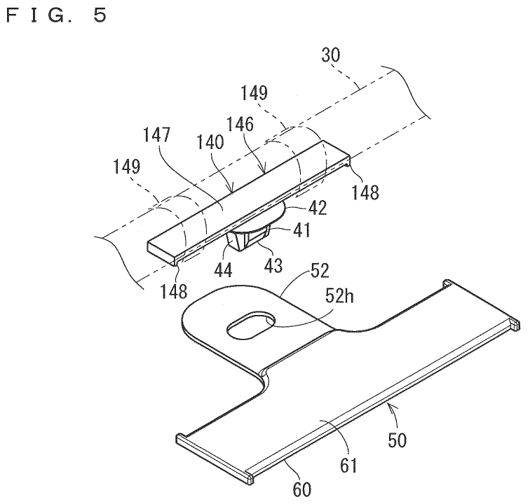

A wiring fixing member 140 according to a first modification example illustrated in FIG. 5 includes the vehicle fixing part 41 and a wiring fixing part 146. The vehicle fixing part 41 has the same configuration as that described in the embodiment described above.

The wiring fixing part 146 includes an elongated plate-like part 147 having an elongated plate-like shape. The elongated plate-like part 147 extends to both outer sides from a part of the fixing base part 42 of the vehicle fixing part 41 on a side opposite to the columnar part 43. A retaining protrusion 148 protruding to one side of the elongated plate-like part 147 is provided to both end portions of the elongated plate-like part 147. The wiring 30 is disposed along a longitudinal direction of the elongated plate-like part 147 in a surface of the elongated plate-like part 147 opposite to the vehicle fixing part 41. In this state, a banding member 149 such as an adhesive tape or a banding band is tied to the wiring 30 and the elongated plate-like part 147. Accordingly, the wiring 30 is held in the wiring fixing part 146. In this state, the retaining protrusion 148 can suppress the banding member 149 coming out from both outer sides of the end portion of the elongated plate-like part 147.

Also in a case where the wiring 30 is fixed to the fixing target region 10 by the wiring fixing member 140 described above, the additional wiring fixing member 50 is fixed to the additional wiring 34 in the manner similar to the embodiment described above, thus the wiring 30 can be fixed to the fixing target region 10 using the vehicle fixing part 41 of the wiring fixing member 140.

The configuration that the additional wiring holding part 60 of the additional wiring fixing member 50 holds the additional wiring 34 needs not be the configuration of including the elongated plate-like part 61.

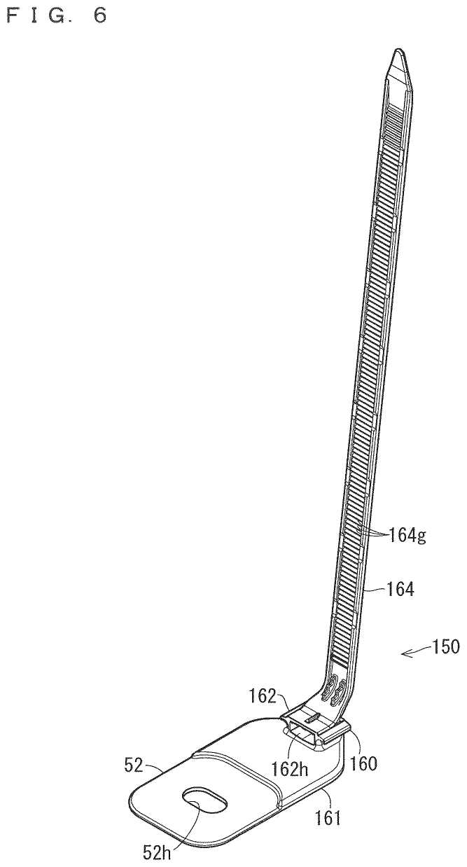

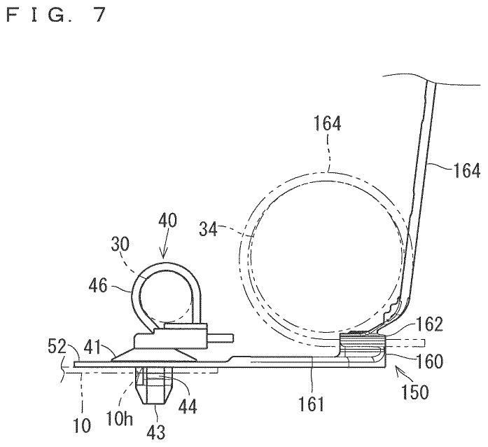

An additional wiring fixing member 150 according to a second modification example illustrated in FIG. 6 and FIG. 7 includes a plate-like vehicle fixing part 52 and an additional wiring holding part 160. The plate-like vehicle fixing part 52 has the same configuration as the plate-like vehicle fixing part 52 in the embodiment described above.

The additional wiring holding part 160 includes a base plate part 161, a band fixing part 162, and a band part 164.

The base plate part 161 is a plate-like part extending from an end portion of the plate-like vehicle fixing part 52. In the present embodiment, the base plate part 161 is thicker than the plate-like vehicle fixing part 52. The band fixing part 162 is formed on the end portion of the base plate part 161 on a side opposite to the plate-like vehicle fixing part 52.

The band fixing part 162 includes a band insertion fixing hole 162h with a rectangular cylindrical shape into which the band part 164 can be inserted. A band locking part which can be locked to a locking groove 164g of the band part 164 is provided to protrude in the band insertion fixing hole 162h in the manner similar to the band locking piece 47a in the embodiment.

The band part 164 is an elongated band-like part extending from the band fixing part 162. The plurality of locking grooves 164g are formed in one main surface of the band part 164 along a longitudinal direction of the band part 164 in the manner similar to the locking groove 48g in the embodiment.

Herein, the band insertion fixing hole 162h passes through the band fixing part 162 in a direction away from the insertion hole 52h of the plate-like vehicle fixing part 52. The band part 164 is deformed into an annular shape in a plane passing through the band insertion fixing hole 162h and the insertion hole 52h to be able to be wound around the additional wiring 34.

Then, the band part 164 is inserted into the band insertion fixing hole 162h while the band part 164 is wound around the additional wiring 34 to have the annular shape, and is kept in a state of being wound the additional wiring 34. Accordingly, the additional wiring 34 is held in the additional wiring holding part 160. A part of the band part 164 getting out of the band insertion fixing hole 162h may be cut and removed.

The present additional wiring fixing member 150 may be an integrally-molded component made by resin or a component in which resin and metal are combined by insert molding.

According to this modification example, the state where the band part 164 is wound around the additional wiring 34 is kept by the band fixing part 162, thus the additional wiring 34 can be held without the other banding member.

In the present modification example, the plate-like vehicle fixing part 52 extends in the direction intersecting with (herein, the direction perpendicular to) the central axis of the annular band part 164 while the band part 164 is wound around the additional wiring 34 to have the annular shape.

Thus, the additional wiring 34 held by the additional wiring holding part 160 adjacent to the plate-like vehicle fixing part 52 can be easily fixed in the state of being parallel to the wiring 30.

As described above, it is sufficient that the additional wiring holding part holds the additional wiring by itself or in combination with the other component. The additional wiring holding part may be a plate-like part in which a fixing hole is formed, for example. In this case, the vehicle fixing part 41 of the wiring fixing members 40 and 140 described above may be inserted into the fixing hole and held in the additional wiring holding part while the additional wiring 34 is fixed to the wiring fixing members 40 and 140.

Described in each embodiment described above is the example that the plate-like vehicle fixing part 52 is sandwiched between the fixing target region 10 and the fixing base part 42. The plate-like vehicle fixing part 52 may be sandwiched between the fixing base part 42 and the locking piece 44. In this case, the wiring 30 and the additional wiring 34 are held separately on both surfaces of the fixing target region 10. It is sufficient that the plate-like vehicle fixing part 52 gets close to the fixing target region 10 while the vehicle fixing part 41 is in the state of being fixed to the fixing hole 10h of the fixing target region 10, a tip end of the vehicle fixing part 41 is inserted into the insertion hole 52h of the plate-like vehicle fixing part 52, and the locking piece 44 is locked to the edge of the insertion hole 52h. Thus, the additional wiring 34 can be fixed to the fixing target region 10 even when the vehicle fixing part 41 is not taken out from the fixing target region 10.

Each configuration described in the embodiments and modification examples thereof can be appropriately combined as long as they are not contradictory.

### EXPLANATION OF REFERENCE SIGNS

10 fixing target region
10h fixing hole
20 wiring fixing structure
30 wiring
32 wire-like transmission member
34 additional wiring
36 wire-like transmission member
40, 140 wiring fixing member
41 vehicle fixing part
42 fixing base part
43 columnar part
44 locking piece
46, 146 wiring fixing part
47 band fixing part
47a band locking piece
47h band insertion fixing hole
48 band part
48g locking groove
50, 150 additional wiring fixing member
52 plate-like vehicle fixing part
52h insertion hole
60, 160 additional wiring holding part
61 elongated plate-like part
62 protrusion part
64 banding member
147 elongated plate-like part
148 retaining protrusion
149 banding member
161 base plate part
162 band fixing part
162h band insertion fixing hole
164 band part
164g locking groove

1. An additional wiring fixing member for fixing an additional wiring to a fixing target region using a wiring fixing member including a vehicle fixing part inserted and fixed to a fixing hole of the fixing target region on a side of a vehicle, the additional wiring fixing member comprising:
a plate-like vehicle fixing part formed into a plate-like shape with an insertion hole into which the vehicle fixing part can be inserted and sandwiched between the vehicle fixing part and the fixing target region to be fixed to the fixing target region; and
an additional wiring holding part continuously formed with the plate-like vehicle fixing part to hold the additional wiring wherein
the additional wiring holding part includes an elongated plate-like part, and
the plate-like vehicle fixing part partially protrudes from a longitudinal intermediate part of the elongated plate-like part.

2. The additional wiring fixing member according to claim 1, wherein
a banding member is tied to the additional wiring and the elongated plate-like part while the additional wiring is disposed along the elongated plate-like part, thus the additional wiring is held in the additional wiring holding part.

3. The additional wiring fixing member according to claim 2, wherein
the plate-like vehicle fixing part extends in a direction intersecting with the elongated plate-like part from a longitudinal intermediate part of the elongated plate-like part.

4. (canceled)

5. (canceled)

6. A wiring fixing structure for fixing a wiring and an additional wiring to a fixing target region on a side of a vehicle, comprising:
a wiring fixing member including a vehicle fixing part inserted and fixed to a fixing hole of the fixing target region; and
an additional wiring fixing member including a plate-like vehicle fixing part formed into a plate-like shape with an insertion hole into which the vehicle fixing part can be inserted and an additional wiring holding part continuously formed with the plate-like vehicle fixing part to hold the additional wiring, the additional wiring holding part including an elongated plate-like part, and the plate-like vehicle fixing part partially protruding from a longitudinal intermediate part of the elongated plate-like part, wherein
a peripheral edge of the insertion hole in the plate-like vehicle fixing part is sandwiched between the vehicle fixing part and the fixing target region to be fixed to the fixing target region.

7. The additional wiring fixing member according to claim 1, wherein
the vehicle fixing part includes a locking part locked to an edge of the fixing hole in a state of not getting out of the fixing hole and a fixing base part located in a surrounding part of the fixing hole on a side opposite to the locking part, and
the fixing target region and the plate-like vehicle fixing part are sandwiched between the locking part and the fixing base part while being overlapped with each other, thus the vehicle fixing part is fixed to the fixing target region.

8. The wiring fixing structure according to claim 6, wherein
the vehicle fixing part includes a locking part locked to an edge of the fixing hole in a state of not getting out of the fixing hole and a fixing base part located in a surrounding part of the fixing hole on a side opposite to the locking part, and
the fixing target region and the plate-like vehicle fixing part are sandwiched between the locking part and the fixing base part while being overlapped with each other, thus the vehicle fixing part is fixed to the fixing target region.
